(19) United States
(12) Patent Application Publication
(10) Pub. No.: US 2007/0212512 A1
(43) Pub. Date: Sep. 13, 2007

(54) HARD-COPY FOR ANTI-SHRINK - ANTI-COPY OPTICAL MEDIUM

(76) Inventor: Richard H. Selinfreund, Terre Haute, IN (US)

Correspondence Address: KELLEY DRYE & WARREN LLP, 400 ATLANTIC STREET, 13TH FLOOR, STAMFORD, CT, 06901, US

(21) Appl. No.: 11/555,565

(22) Filed: Nov. 1, 2006

Related U.S. Application Data
(60) Provisional application No. 60/732,757, filed on Nov. 1, 2005.

(51) Int. Cl. B32B 3/02

(52) U.S. Cl. 428/64.4

(57) ABSTRACT

A recording medium configured to unmask read of data thereon, or a portion of data thereon, upon an optical state change of a state change material on or in the recording medium, said recording medium having a code stored thereon which causes interrogation for a verification material on or in the recording medium and which permits full read of the information stored on the medium only if such verification material is detected in a defined manner.

### RELATED APPLICATIONS

This application claims priority to U.S. Provisional Patent Application No. 60/732,757 filed Nov. 1, 2005. The disclosure of each such application is hereby incorporated by reference in its entirety where appropriate for teachings of additional or alternative details, features, and/or technical background, and priority is asserted from each.

### BACKGROUND OF THE INVENTION

1. Field of the Invention

The present invention generally relates to a hard-coat composition for the production of anti-shrink/anti-copy optical medium.

2. Description of the Related Art

The development of software and other forms of content data, such as visual and auditory digital data, represents a large investment in time and money. Such content data is often stored in digital form on a transportable storage medium which is then sold to a purchaser. Unfortunately, with most traditional transportable digital recording media, clandestine movement from of the recording medium from its intended distribution path is relatively easy, extraction of the data from the transportable storage media is possible along its distribution chain is relatively easy and the production of illicit copies of copyrighted material stored on the recording medium is relatively simplistic even for the relatively uninitiated in computer science.

To offset the costs of shoplifting of transportable recording medium, retailers pass on losses to consumers in the form of higher retail prices. To offset the losses occurring in the distribution chain, and in illicit copying of information stored on the transportable recording medium, purveyors charge higher prices to retailers. In the end, consumers pay considerably higher prices for recording medium due to such illicit activities.

There have been numerous attempts to curb content data piracy on transportable digital recording media. In one approach, a serial number is placed in the content data to allow for tracing of unauthorized copies of the serialized content data. The problem with this method is that it requires the task of external enforcement to track down illegal copies and is of relatively little use when the item is not associable with a particular person. Further, hackers of a number of such systems have found it relatively easy to locate and erase the serial numbers.

To deter shoplifting and distribution chain theft, some entities employ electronic article surveillance (EAS) systems that include transponder tags (RFID, etc.) attached to each article of merchandise. With respect to transportable digital recording media, such transponder tags are typically associated with the packaging surrounding the media. EAS systems further include one or more electronic readers positioned at exits to detect the transponder tags. When an item is purchased, or is removed from the distribution chain in an authorized manner, the transponder tag is disabled or removed from the article and the merchandise may pass by the reader without sounding an alarm. When a person attempts to remove an article without authorization, the reader detects the transponder tag that has not been disabled or removed from the article and sounds the alarm.

As transportable digital recording media is often small and easily concealed, EAS systems are easily overcome by simply removing the desired recording medium from its packaging, concealing the medium and then concealingly removing the medium. After the media is removed, the data thereon can generally be copied easily. Placing RFID directly on the digital recording medium has been ruled out for several reasons, including the cost of the recording medium, the difficulty in placing the RFID in a manner to provide a read through a package, and the radio frequencies employed by such systems not being approved for in-flight use.

Theft may also occur when the purveyor of merchandise allows customers or distributors to freely return merchandise even in the absence of proof of purchase, if the merchandise being returned is carried by the sales outlet. Some persons purchase merchandise at reduced sale prices, or pilfer such merchandise, and then return the merchandise to the same or another purveyor for exchange or refund, claiming to have paid full price for the merchandise. In respect of digital recording media, a request for a refund may come after the content of the digital recording medium has been downloaded. If the purveyor refunds the full price, the purveyor loses the amount in excess of the purchase price in addition to the cost of processing the returned merchandise.

Another problem associated with software, whether licitly obtained or illicitly obtained, is that software may be easy to copy and reproduce using easily available technology.

Coatings, such as hard-coats, may be applied to optical discs to eliminate the need for cartridges to protect the media's recording layer. They may also be useful in increase digital content accuracy, compatibility and reliability. Coatings may be applied in a post production process, for example, as a final step in disc manufacturing or during the disc printing step.

There is a need for improved anti-theft/anti-copy recording medium, in particular digital recording medium, and a method for fabricating the same. It would be useful if such anti-theft/anti-copy recording medium could be produced by simply including an anti-theft/anti-copy composition in the recording medium.

### DEFINITIONS

“Digital Datum Indicia”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a digital data read.

“Digital Reader”: any device capable of detecting and reading digital information that has been recorded on an Digital Recording Medium. By the term “reader” it is meant to include, without limitation, a player. Examples are CD and DVD readers.

“Digital Recording Medium”: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. information stored on the medium may include, without limitation, software programs, software data, sensory files, audio files and video files.

“Light-Activated State-Change Material”: a State-Change Material that alters a measurable state function upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader (as defined below) for the reading of Optical Medium.

“Permanent State-Change Material”: a State-Change Material that once activated to change a measurable state function upon application of energy to the material, stays in such state permanently or for a prolonged period of time.

“State-Change Material”: a material capable of altering a measurable property of the material upon activation of the material by application of energy to the material. By “state change material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure, materials that shrink upon application of heat) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material spontaneously in a short period of time (minutes or less), loses such change in the measurable property. It includes, without limitation, materials that move from a first state to a second state upon application of energy, and back to the first state without application of energy.

“Transportable Recording Medium”: a relatively small medium capable of being transported by hand from one location to another. It includes, without limitation, Transportable Digital Recording Medium such as an optical disc, a floppy disk, a flash drive.

For the purpose of the rest of the disclosure, it is understood that the terms as defined above are intended, whether such terms are in all initial cap or not.

### SUMMARY OF THE INVENTION

Applicant has disclosed in his previous application the use of materials, including transient state change materials, placed on a recording medium to effectuate anti-copy and anti-theft applications. The materials are placed in a manner to prohibit read and/or copying of the content on the recording material by altering data reads that would exist but for the application of the material to the medium. For example, state change material may be placed in a anti-theft manner to block read of content until the material is activated by an energy source to a state that allows the actual data structures associated with the material to be read as typically read by an reader. State change material may be placed on or in a recording medium, such as an optical disc, in an anti-copy manner by, for example, causing the actual data structures associated with the material to be read differently depending upon the time of read, and requiring software to detect the material and to take into account the different data structure reads to allow the medium to be read only if the pre-determined data read change is found, and/or the data read change is appropriately located on the medium. Anti-copy protection may also be effectuated by coupling read of the disc to software that requires a particular detection to be found upon the read that this not typically associated with a software disc (e.g., an aberration in read speed, or detection of an emission from a material).

Techniques for applying such materials should take into account the present conventional system of producing recording medium, such as optical recording medium.

In one embodiment of the invention, there is provided a coating material, such as a hard-coat, that contains a composition designed to be de-activated by a security check out system, The coating material composition produces an opacity blocking the read of an optical reader (for example, limits the transmission of a laser emission from the optical reader, and/or receipt of the reflected/refracted transmission). The change in opacity is selected so as to stop an optical medium from being read by an optical reader. However, the coating material is selected such that upon activation by an activation source (such as impingement of the coating material by one or more emissions) that the optical medium can not be read (or the portion of the medium upon which coating is placed can not be read). Activation emissions may be selected such that activation may take place through packaging retaining the optical medium.

In another embodiment, the coating contains an anti-copy composition, which may be the same or different from the anti-shrink composition, which is detectable by software designed to determine its existence on or in the coating on the optical medium and which may be designed to detect the particularly location of the anti-copy composition on or in the coating of the optical medium optical medium. Any measurable parameter, for example, measurable by the optical reader, may be used to determine the existence/location of the anti-copy composition, and such parameter may be measured under conventional or non-conventional conditions with respect to conventional read conditions. For example, a transient change in reflectance may be measured when the optical medium player velocity exceeds more than one times the angular velocity. Thus a change in the predicted angular velocity of the optical media may be used to detect the material. Or, for example, the composition may be detected by noting changes in the read head movement. Or, for example, the composition may cause a change in predicted drive speed. As different readers, for example a DVD reader versus a computer reader, may elicit different parameters, such as read speed, laser wavelength emission, emission power, etc.,) anti-copy software designed to limit read of the optical medium comprising an copy-protection composition may be designed to prohibit read on one or more reader determining on the parameters being measured (that is, whether the parameter is different on the various optical readers).

Such anti-copy and/or anti-shrink compositions may be used in conjunction in conjunction with other known techniques known in the art for protection against shrinkage and or illicit optical medium copying. For example, security tags in labels can also be employed along with the anti-copy/anti-shrink coating composition.

In another embodiment, the anti-shrink coating contains a composition that activates a optical data change material that is associated with another component of the optical disc, such as applied to the pit/land surface. Such optical data change material, which may be a transient optical state change material, may require activation from the composition in the anti-shrink coating order for it effectuate a measurable change in respect to the data read of the optical medium

In yet another embodiment, the anti-shrink/anti-copy shrink coating, such as hard-coat, also comprises an limited-time play composition. Such limited-time play material may, for example, be a permanent optical state material that over a period of time blocks read of the optical medium. The limited-time play material may also be a time-delayed optical state-change material that is activated upon removal of the optical medium from its packaging housing after a period of time, allowing read of the optical medium until the optical state-change is of such a quality to block read. Such time-delayed material or composition may be selected such that it may be reverted back (for example, by impingement with an emission source) to an optical state that allows read of the optical medium. Therefore, the time-delayed material/composition may be selected such that the material/composition allows for read of the optical medium when the optical medium is removed from its packaging, over time prohibit read of the optical medium due to an optical state change that blocks read, and upon activation with an appropriate activation source snap-back to an optical state that once more permits read of the optical medium. The latter provides for a product that may be sampled by consumers in a retail setting, but which would not be useable by a consumer that illicitly steals the product (as the material would change opacity over time to block read). However, a licit purchaser who had the same optical medium with time delayed material/composition run through an appropriate activation source, would be able to read the optical medium thereafter.

In another embodiment, a recording medium having a hard coat is applied on one or more surface of the medium, the hard coat comprising a dye substance selected from the group consisting of at least one of: sudan blue, sudan II, propylene blue, bromophenol blue, HIDCI, and congo red.

In yet another embodiment, a recording medium is configured to unmask read of data thereon, or a portion of data thereon, upon an optical state change of a state change material on or in the recording medium, said recording medium having a code stored thereon which causes interrogation for a verification material on or in the recording medium and which permits full read of the information stored on the medium only if such verification material is detected in a defined manner.

### DETAILED DESCRIPTION OF THE INVENTION

One particularly useful method found by the applicant for protecting against piracy by theft and/or illicit copying has been to incorporate on the transportable recording medium a material positioned on the medium in a manner to block read of information on the medium (in whole or in part) until such medium is activated by an energy source. In one embodiment, such method may further employ software and/or hardware components to detect the material on the medium and to unlock information on the medium based on the detection of the material on the medium, the detection of a property associated with the material, a change in properties of the material noted upon a first read (along one or more portions of the medium) of the medium and one or more subsequent reads (along one or more portions of the medium), or based on detecting the material at a predetermined location of such material. In another embodiment, such material is placed on the medium in a manner that it physically prevents read of one or more portion (including all) of the information on the medium, but upon manipulation of the material, as by way of, for example, activation, heating, erasing, of the material etc., allows read of such one or more portion of information. Such methods are particularly useful with respect to digital recording medium

As would be understood by one of skill in the art, the anti-copy methods described herein, and in other of the present inventor's patent applications, can be used in conjunction with the anti-theft methods described herein, and in other of the present inventor's patent applications, on the same recording medium, such as digital recording medium. Furthermore, anti-copy methods of others may be used with anti-theft methods described herein, in other of the present inventor's applications, and anti-theft methods of others may be used with anti-copy protection methods described herein, and in other of the present inventor's applications. For example, materials in or on the medium may effectuate the anti-copy and/or anti-theft technique in conjunction with physical changes in the medium which may be used to effect anti-copy methods (for example, detecting a scratch on the medium, unconventional pits and/or lands which lead to ambiguous data reads).

Materials may be placed so as to prevent read of one or more portions (or all) of information on the recording medium until activated by an energy source, and materials may be placed on such medium in a manner that inhibits copying of one or more portions (or all) of information on the recording medium, either due to physical interference with the copying/read process (brought upon, for example, the material leading to two different data outputs, such as a valid-to-valid data change, a valid-to-error data change (or vice versa), an error-to-error data change), and/or due to software/hardware requiring detection of the material and/or activated material for read of the medium (or portion thereof), which is associated with the medium itself or the hardware upon which the medium is read, associated with hardware on a processor communicating with the hardware upon which the medium is read.

In one embodiment, an anti-shrink composition is added to the hard coat of an optical medium. In such embodiment, the optical medium is unreadable until activation at pre-determined wavelengths makes the coating of a character that permits the read emission to pass through and its transmitted return emission to be read. For example, the hard coat may comprise an anti-shrink composition that may be deep blue, but upon activation becomes a permanent clear coat.

In another embodiment, the anti-shrink coating further activates an anti-copy composition positioned with respect to another facet of the optical medium (such as on its surface or within/on a pit or land, for example by spin coating at the pit/land level before metallization). Thus, the optical medium may be activated from an non-readable optical state to a readable state, but not allowed to be read and/or copied by software associated with the optical medium unless the anti-copy material is appropriately associated with the optical medium.

In another embodiment, the same or different activation beams can be used to activate the anti-shrink material in the coating, and to activate the anti-copy composition associated with the recording medium, e.g., optical medium.

In an embodiment, activation signals may be directed to a specific radius on the medium, such as a disc, or a particular location on the medium rather than one or more entire surface of the medium being activated.

In one embodiment, locking software may be present on the recording medium, the locking software locking read of the medium if certain conditions are not met with respect to the recording medium. For example, the locking system might use the predictable deviation form if a predicted angular velocity is used to distinguish between an authentic optical medium from a copy. By selecting the appropriate composition, the activation can be such that it does not effect the angular velocity at one time the playable speed, but does affect when the velocity of the medium is greater than one time playability speed, for example upon copying. As a further example, authoring software may, for example, provide instructions for the player to either jump between two files, and provide for an unexpected head movement or drive speed change. The locking software may be designed to anticipate unique head movements at pre-determined locations, such that when the copy protection material is not there, the anticipated drive head movement or speed is not found. The locking software may then transact commands that make the optical medium unable to be read.

### EXAMPLE 1

Optical medium having a copy-protection composition coated at the pit/land interface and anti-shrink composition on the laser incident side was read at a scanning velocity of 3.49 m/sec at different radii and drive speeds.

| | |
|---|---|
| Scanning Velocity | 3.49 m/sec |

Table Entries are milliseconds per revolution

| | Drive Speed (X) | | | | | |
|---|---|---|---|---|---|---|
| Radius (mm) | 1 | 2 | 4 | 8 | 16 | 24 |
| 24 | 43.208 | 38.895 | 17.506 | 3.940 | 0.443 | 0.033 |
| 26 | 46.809 | 42.136 | 18.965 | 4.268 | 0.480 | 0.036 |
| 28 | 50.410 | 45.377 | 20.424 | 4.596 | 0.517 | 0.039 |
| 30 | 54.010 | 48.618 | 21.882 | 4.924 | 0.554 | 0.042 |
| 32 | 57.611 | 51.860 | 23.341 | 5.253 | 0.591 | 0.044 |
| 34 | 61.212 | 55.101 | 24.800 | 5.581 | 0.628 | 0.047 |
| 36 | 64.812 | 58.342 | 26.259 | 5.909 | 0.665 | 0.050 |
| 38 | 68.413 | 61.583 | 27.718 | 6.238 | 0.702 | 0.053 |
| 40 | 72.014 | 64.824 | 29.177 | 6.566 | 0.739 | 0.055 |
| 42 | 75.614 | 68.066 | 30.635 | 6.894 | 0.776 | 0.058 |
| 44 | 79.215 | 71.307 | 32.094 | 7.223 | 0.813 | 0.061 |
| 46 | 82.816 | 74.548 | 33.553 | 7.551 | 0.850 | 0.064 |
| 48 | 86.416 | 77.789 | 35.012 | 7.879 | 0.887 | 0.067 |
| 50 | 90.017 | 81.031 | 36.471 | 8.207 | 0.924 | 0.069 |
| 52 | 93.618 | 84.272 | 37.929 | 8.536 | 0.960 | 0.072 |
| 54 | 97.218 | 87.513 | 39.388 | 8.864 | 0.997 | 0.075 |
| 56 | 100.819 | 90.754 | 40.847 | 9.192 | 1.034 | 0.078 |
| 58 | 104.420 | 93.995 | 42.306 | 9.521 | 1.071 | 0.080 |

Table entries are the ratio of the spot size to circumference
where spot size is 1 micron.

| Radius (mm) | |
|---|---|
| 24 | 6.63E−06 |
| 26 | 6.12E−06 |
| 28 | 5.68E−06 |
| 30 | 5.31E−06 |
| 32 | 4.97E−06 |
| 34 | 4.68E−06 |
| 36 | 4.42E−06 |
| 38 | 4.19E−06 |
| 40 | 3.98E−06 |
| 42 | 3.79E−06 |
| 44 | 3.62E−06 |
| 46 | 3.46E−06 |
| 48 | 3.32E−06 |
| 50 | 3.18E−06 |
| 52 | 3.06E−06 |
| 54 | 2.95E−06 |
| 56 | 2.84E−06 |
| 58 | 2.74E−06 |

In yet another embodiment, the anti-shrink coating can provide for the copy-protection security coating (i.e., protecting against illicit copying).

In yet another embodiment, the anti-shrink and copy-protection composition may be two different components, each added to the coating material. For example, the anti-shrink component may be non-reversibly bleached at a retail location, allowing the medium to be read, or more fully read, while the anti-copy component is later bleached, changed in optical state, etc., during the normal read of the optical medium, with the change of anti-copy component effectuating the copy protection of data on the medium.

In one embodiment, the apparatus upon which the copy-protected optical medium is to be read is instructed by software to increase drive speed above the normal play speed of the optical disc which differs from copy speed. In such embodiment, parameters associated with the positioning of the copy-protection material with respect to the optical medium can be read. If such parameters selected for read differ at both the authentication speed and the copy speed, such parameters may be used by the software to lock read. Measured parameters may include, without limitation, hard drive velocity or read head movements.

In one embodiment, the copy protection material may be used for example to induce a reversible analog error at a pre-determined position.

In fabrication of anti-shrink/anti-copy optical media, the medium in one embodiment may first be coated with the anti-shrink material, then the anti-copy material, or vice versa. The software may be designed to read where the anti-copy material is located. The software may, alternatively or in conjunction, be designed to detect a change associated with activation of the anti-copy material such as an error upon the first read, and a valid read upon a second read. The change may be used to authenticate the optical medium and allow the software to permit read of the optical medium, or a portion thereof.

In an embodiment, the anti-shrink material and anti-copy material are the same. For example, the anti-shrink material may comprise state change material that changes, for example, from an opaque state where data read by the read beam of an optical reader is physically blocked to a transparent state wherein data read is no longer physically blocked from being read. Read algorithms associated with the medium may be selected to detect the anti-shrink material in its transparent state and to prohibit read algorithmically unless the transparent anti-shrink material is detected and/or its location on the medium in such transparent state matches a certain profile. Thus, in such example, the transparent state anti-shrink material acts as the anti-copy material in that, as read, is interfered with (so as to prevent illicit copying).

Velocity measurements may also be used to authenticate an optical medium. For example, drive commands may be included in the software causing read at point 1 of the optical medium of the velocity. Anticipated angular velocity at point 2 as compared to point one may be used by the software to authenticate the optical medium and to allow, for example, read and/or copying of the data on the medium. For example, if the angular velocity at point one is greater than the angular velocity at point 2, then the software can be written so as to authenticate the disc. As would be understood, such measurements can be made anywhere on the optical medium which may be read by the reader, for example, in the non-VOB area.

Application of the anti-shrink/anti-copy systems to the optical medium may be by numerous techniques. For example, the systems could be applied one after another in a spin coat before hard coat, applied together in a spin coat before the hard coat, applied one after another in two hard coat steps, applied in the hard coat together, sputter coated and applied before the metal layer, sputter coated and applied before the hard coat, sputter coated and applied during the metallization step, or sputter coated with a photomasking (with the systems placed for example in the lead in or the burst cutting areas).

The anti-shrink/anti-copy composition may comprise materials that change parameters upon impingement with, in the case of the anti-shrink material, the read activation emission source, and in the case of the copy-protection material, the emission of the optical reader.

For example, copy protection materials may include molecules that absorb at 650 nm, such as indigoid materials (such as N,N′-dimethyl indigo, N,N′-dimethyl-5,5′,7,7′-tetrabromo indigo, and N,N′-ethyl indigos), triarylmethanes (including trimethylmethanes where R=N(CH₃)₂, R′=H; R=N(C₂H₅)₂, R′=H; R=N(CH₃)₂, R′=N(CH₃)₂; R=N(C₂H₅)₂, R′=N(C₂H₅)₂), spiropyrans, or 4,4′,7,7′-tetra-substituted-1,1′,3,3′-tetraethylbenzimidazololtriazatrimethine cyanines. For example, useful materials may include, indigo, synthetic (CAS#482-89-3), malachite green oxalate (CAS #2437-29-8), brilliant green (CAS#633-0304), crystal violet (CAS#1548-62-9), ethyl violet (CAS# 2390-5-2), indigo, synthetic (available from Cross Organics Catalog No. 1 212130250) or analogs thereof.

The anti-copy compositions may comprise materials such as. HIDCI (Aldrich No. 25,733-8), sudan blue (Aldrich No. 30,643-6), sudan II (Aldrich No. 19-965-6), propylene blue, bromophenol blue, congo red etc. or analogs thereof.

| | | | |
|---|---|---|---|
| 306436 | Sudan | Blue | II |
| Sigma-Aldrich | | | |

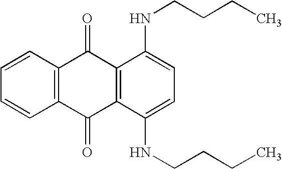

| | | |
|---|---|---|
| 199656 | Sudan | II |
| Aldrich | | |

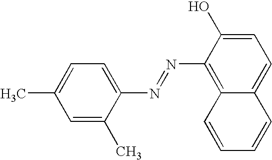

| | | |
|---|---|---|
| 257338 | 2-[5-(1,3-Dihydro-1,3,3-trimethyl-2H-indol-2-ylidene)-1,3-pentadienyl]- | iodide |
| Aldrich | 1,3,3-trimethyl-3H-indolium | |

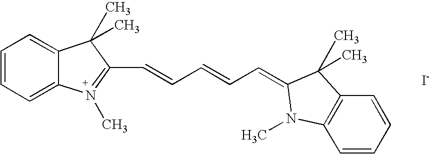

| | | |
|---|---|---|
| 114391 | Bromophenol | Blue |
| Sigma-Aldrich | | |

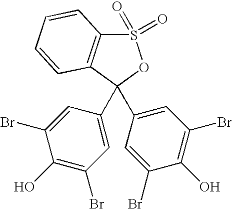

| | | |
|---|---|---|
| 32651 | Congo | Red |
| Riedel-de Haën | | |

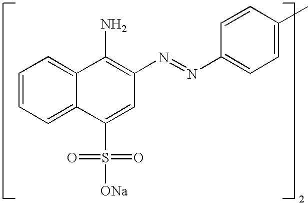

The concentration of such materials may be selected to give, for example, an OD of approximately 1 at 650 nm.

The anti-shrink materials may comprise similar optical state change materials, but the composition typically will allow activation only once, e.g., staying in the photobleached or optically clear state, the state permitting read.

### EXAMPLE 2

36.4 milliliters of HEMA or PMMA is added to 230 milliliters of methoxy propanol, 7.5 grams of bis tris, and 3.75 grams of methylene blue dye. The components are mixed overnight, and pre-filtering is performed using a 1.5 mm vacuum filtration. Filtering may be with a sandwich system having a 1.5 mm filter on top of durapore 0.22 um filter. Removal of oxygen from the reaction may cause a blue photobleach to irreversibly stay photobleached.

Anti-shrink/anti-copy systems may also include electron transfer agents, or proton donors, such as trisulfonium hexfluoro antimonite (Alrich No. 40,722-4), trisulfonium hexafluoro phosphate (Aldrich # 40,721-6), 2-(4-methoxystyryl)-4,6-bis(trichloromethyl)-1,3,5-triazine (Aldrich No. 530964), (4-bromophenyl)diphenylsulfonium triflate (Alrich No. 527041), diphenyliodonium hexfluorophosphate (Aldrich No. 548014), diphenyliodonium p-toluenesulfonate (Aldrich 530980) HEMA or PMMA or analogs thereof:

### 530964 2-(4-Methoxystyryl)-4,6-bis(trichloromethyl)-1,3,5-triazine

Aldrich

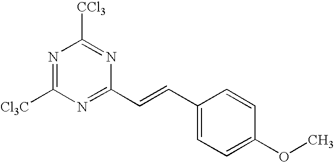

### 527041 (4-Bromophenyl)diphenylsulfonium triflate

Aldrich

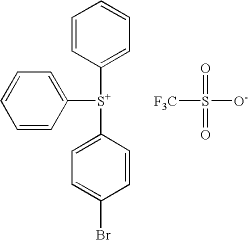

### 548014 Diphenyliodonium hexafluorophosphate

Aldrich

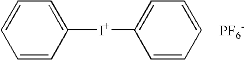

### 530980 Diphenyliodoniump-toluenesulfonate

Aldrich

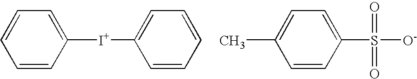

Such compositions may in lieu, or in conjunction with such donors, use materials that photobleach without proton exchange such as HIDCI (Aldrich No. 25,733-8)

### 257338 2-[5-(1,3-Dihydro-1,3,3-trimethyl-2H-indol-2-ylidene)-1,3-pentadienyl]-1,3,3-trimethyl-3H-indolium iodide

Aldrich 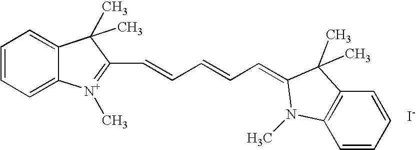
or alternative acid generators such as:

### 530964 2-(4-Methoxystyryl)-4,6-bis(trichloromethyl)-1,3,5-triazine

Aldrich

### 527041 (4-Bromophenyl)diphenylsulfonium triflate

Aldrich

### EXAMPLE III

30-300 mls of HEMA, such as 72.8 mls, is added to a coating solution along with 10-500 mls of methoxy propanol (such as 194 mls), and 7.5 grams of bis Tris (as an electon donor), and 1.75 grams of a UV dye and/or 1.75 grams of a photobleachable IR dye, for example, KF 1166 from Honeywell (Morristown, N.J.). The optical density of the combined dyes may be selected to give approximately 1 absorbance unit at 650 nm, 405 nm, and/or 780 nm. Section is made that after photobleach, the absorbance at 405, 650 and 780 nm is below 0.2 AU.

### EXAMPLE IV

A optical disc is spin coated using a spin processor with a dye system in hard coat (300 ul to 5 milliliters) at a speed of 600 rpm for 2-4 seconds, with a dwell of 2000 rpm for 4 seconds, a spin off of 5000 rpm for 12 seconds, and a bake of 15 minutes at 40 degrees C.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. (canceled)

2. (canceled)

3. (canceled)

4. A recording medium configured to unmask read of data thereon, or a portion of data thereon, upon an optical state change of a state change material on or in the recording medium, said recording medium having a code stored thereon which causes interrogation for a verification material on or in the recording medium and which permits full read of the information stored on the medium only if such verification material is detected in a defined manner.

5. A recording medium of claim 4 wherein the state change material and verification material are the same.

6. A recording medium of claim 5 wherein the code is configured to cause a check for the verification material in a particular optical state but not another optical state.
